(19) United States
(12) Patent Application Publication
(10) Pub. No.: US 2009/0160607 A1
(43) Pub. Date: Jun. 25, 2009

(54) VEHICLE KEY FOB HAVING A COMMUNICATIONS CIRCUIT

(75) Inventors: Ryan M. Edwards, Macomb, MI (US); Carl J. Hering, Farmington Hills, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: General Motors Corporation, Detroit, MI (US)

(21) Appl. No.: 11/963,125

(22) Filed: Dec. 21, 2007

(51) Int. Cl. G05B 19/00

(52) U.S. Cl. 340/5.61

(57) ABSTRACT

A vehicle key fob for communicating information between one or more electronic devices, such as a personal or laptop computer, and a wireless-enabled vehicle. In one embodiment, a wired communications link is established between the electronic device and the vehicle key fob over a wired connection, such as a USB cable. A separate wireless communications link is established between a wireless interface located in the vehicle key fob, such as a wireless adapter, and the wireless-enabled vehicle so that information can be sent from the electronic device to the vehicle, and vice-versa, in a secured manner.

### TECHNICAL FIELD

The present invention relates generally to wireless communications and, more particularly, to wireless communications to and from a vehicle.

### BACKGROUND

With the high level of electronics used in modern vehicles, there has been a proliferation of wireless communications involving the vehicle. For example, vehicle telematics units can transmit data via cellular telephone networks to call centers, they can track their instant location through GPS satellite networks, and they can utilize hands-free technology to provide the occupants with voice communication features, to name but a few of the possible wireless communication applications.

Another wireless technology in widespread use in automotive applications is Remote Keyless Entry (RKE). RKE is a technology which uses an encoded signal, typically sent from a key fob, to lock or unlock vehicle doors, trunk lids or hatches and to activate security systems in the vehicle, for instance. Most RKE key fobs have embedded security features that pair or marry a particular key fob to a particular vehicle, thus, avoiding a situation where a key fob can unlock an unaffiliated vehicle.

### SUMMARY OF THE INVENTION

According to one aspect, there is provided a vehicle key fob comprising a protective housing, a remote keyless entry (RKE) circuit, and a communications circuit. The communications circuit includes a first interface for establishing a first communications link with one or more electronic device(s) and a second interface for establishing a second communications link with a vehicle. The RKE circuit and the communications circuit generally communicate with the vehicle over different channels.

According to another aspect, there is provided a vehicle key fob comprising a protective housing, a wired communications port, and a communications circuit. The wired communications port extends through the protective housing and receives a wired connection from one or more electronic device(s). The communications circuit includes a first interface that is electronically coupled to the wired communications port for establishing a wired communications link with the electronic device(s) and a second interface that includes a wireless adapter for establishing a wireless communications link with a vehicle. The first and second interfaces are electronically coupled to one another so that information can be exchanged between the electronic device(s) and the vehicle through the communications circuit.

According to yet another aspect, there is provided a vehicle key fob comprising a protective housing, a remote keyless entry (RKE) circuit, a wired communications port, and a communications circuit that has a first interface, a second interface, and a memory device. The first interface is electronically coupled to the wired communications port for establishing a wired communications link with the electronic device(s), the second interface is electronically coupled to the first interface and includes a wireless adapter for establishing a wireless communications link with a vehicle, and the memory device is electronically coupled to the second interface and has preprogrammed security features stored thereon that correspond to security features stored at the vehicle.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a schematic drawing of an exemplary system utilizing the vehicle key fob described herein; and

FIG. 2 is a cutaway view of the vehicle key fob of FIG. 1, schematically showing a block diagram of exemplary RKE and communications circuits that could be used.

### DETAILED DESCRIPTION OF THE PREFERRED EMBODIMENT(S)

The vehicle key fob described herein can be used to communicate information between one or more electronic devices, such as a personal or laptop computer, and a wireless-enabled vehicle. According to one embodiment, a wired communications link is established between the electronic device and the vehicle key fob, and a separate wireless communications link is established between the vehicle key fob and the wireless-enabled vehicle. Although possible, it is not necessary for these two communications links to be functioning concurrently, as information sent over one of the communications links can be temporarily stored at the vehicle key fob for subsequent transfer over the other communications link. The vehicle key fob can be used to communicate all different types of information, data, electronic files, programs, scripts, etc. and can be used in one of a number of different applications.

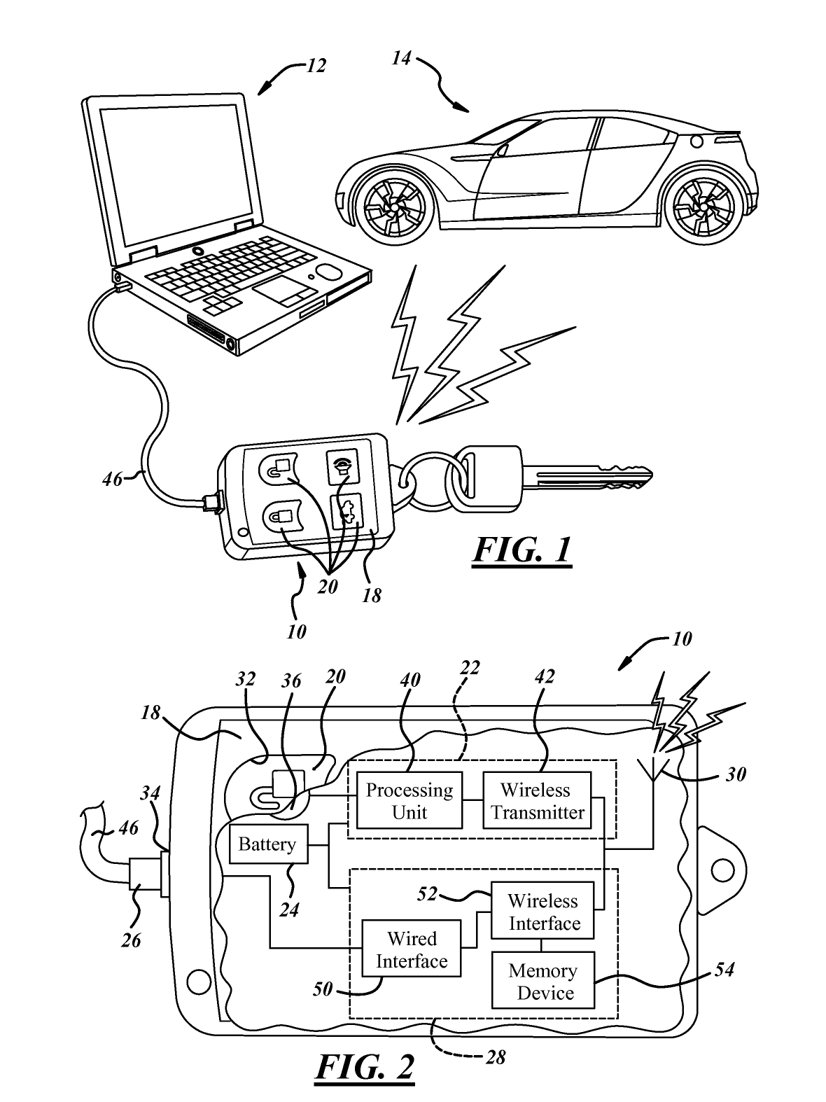

Turning now to FIGS. 1 and 2, there is shown an exemplary embodiment of a vehicle key fob 10 that connects an electronic device, in this case a laptop computer 12, to a wireless-enabled vehicle 14 so that information can be exchanged therebetween. It should be appreciated that vehicle key fob 10 can be used with other electronic devices, including personal computers, server computers, mobile phones, personal digital assistants (PDAs), gaming consoles, digital cameras, music players, and thumb or zip drives, to name but a few. Vehicle key fob 10 generally performs conventional remote keyless entry (RKE) functions and acts as a communications intermediary between laptop computer 12 and vehicle 14. The term “key fob,” as used herein, broadly includes not only separate transmitters attached to a key or set of keys by a loop or tether, but also portable remote transmitters regardless of whether they are attached to keys, as well as remote transmitters that are integrated together with a vehicle key as a single component. According to the embodiment shown here, vehicle key fob 10 generally includes a protective housing 18, several user buttons 20, an RKE circuit 22, a power source 24, a wired communications port 26, a communications circuit 28, and an antenna 30.

Protective housing 18 is an enclosure or casing that generally surrounds and protects the components of vehicle key fob 10. Preferably, housing 18 is formed from a molded rigid plastic or similar material and can include a number of features known in the art. For example, on a rear side of the housing (not shown) there could be a removable cover that provides access to a replaceable battery or other power source. The front side of the housing can include openings 32 for accommodating user buttons 20; the openings can generally be the same size and shape as the corresponding user buttons 20 so that a sealed junction is formed therebetween. Opening or aperture 34 is also formed in housing 18, but this opening is designed to accommodate wired communications port 26, as will be subsequently explained.

User buttons 20 enable a user to selectively activate different RKE functions at vehicle 14, as is generally known in the art. Vehicle key fob 10 can include a number of different combinations of user buttons, including buttons for locking and unlocking a door, arming and disarming a vehicle alarm system, activating a trunk release, panic signaling, remote ignition starting, and turning on interior and exterior lights, to cite some of the possibilities. Of course, other buttons and RKE functions known in the art could also be used, including RKE functions that are performed automatically without the use of user buttons. An example of this type of RKE function is when the vehicle doors are automatically unlocked—without engaging an unlock button—by a vehicle key fob that is within a certain proximity of the vehicle. Each user button 20 is operably coupled to an associated electro-mechanical switch 36 located beneath it, so that when a user presses or otherwise engages the user button the corresponding electro-mechanical switch generates an electronic signal that is sent to RKE circuit 22.

Remote keyless entry (RKE) circuit 22 is at least partially located within protective housing 18 and includes a combination of electronic components designed to receive signals from switches 36, process the signals, and wirelessly transmit command signals to vehicle 14. For the RKE circuit shown here, only a processing unit 40 and a wireless transmitter 42 are shown; however, it should be appreciated that it could include any of a number of different combinations of components known to those skilled in the art and is not limited to the illustrative example shown here. Processing unit 40 generally interprets the signals from switches 36 and includes a suitable electronic processing device, such as a central processing unit (CPU), a microcontroller, a microprocessor, an applications specific integrated circuit (ASIC), or any other suitable processing device. In one embodiment, processing unit 40 is maintained in a power-saving dormant mode until it receives a signal from switch 36; at which time, the processing unit wakes up, processes the incoming signal, and outputs a data stream to wireless transmitter 42. The wireless transmitter modulates or otherwise processes the data stream and sends a radio frequency (RF) signal, hereafter referred to as a command signal, to an RKE receiver located within vehicle 14.

Power source 24 generally provides vehicle key fob 10 with electrical power and can include any type of appropriate battery or other power providing component known in the art. For example, a single battery can be used to power both RKE circuit 22 and communications circuit 28, or multiple batteries can be provided so that each of these circuits has its own dedicated power source. Power source 24 could be a standard replaceable battery such as the type oftentimes found in vehicle key fobs, or it could be a rechargeable battery that is reenergized with energy provided from the electrical device through wired communications port 26. These are only several of the possibilities, as numerous other power source arrangements could also be employed.

Wired communications port 26 physically and electronically connects to a wired connection 46, such as a wire, cable, PC card, etc., and generally provides wired connectivity between vehicle key fob 10 and one or more electronic devices, such as laptop computer 12. As shown in the drawings, wired communications port 26 extends through protective housing 18 to connect wired connection 46 with the internal key fob circuitry. Precautions should be taken to provide this connection in a sealed manner that generally keeps water, dirt and other debris away from the internal components of vehicle key fob 10. Although wired communications port 26 can be any suitable port, jack, interface, junction, receptacle, slot, etc. that is known in the art, it is preferable that it be a standard high-speed electronic interface such as a universal serial bus (USB) port, a FireWire connection, or a PC card slot, to name but a few. It is possible for wired communications port 26 to include a pop-out design where the port is stored in a flush or recessed position within protective housing 18 until a user engages it. Once the port pops-out or extends from the protective housing a USB cable or other wired connection can easily be attached. Alternatively, the port can comprise a USB plug that mates with a USB socket in the laptop 12 so that the key fob 10 can be plugged in directly without a separate cable. It is also possible for wired communications port 26 to connect with multiple electronic devices; one such way is by connecting with a computer networking device like a router. A networked connection like this enables communications circuit 28 to selectively interact with a number of different electronic devices.

In an alternative embodiment, wired communications port 26 is replaced with a high-speed wireless interface, such as those that operate according to the Bluetooth standard, an IEEE 802.11 standard, or some other wireless short-range protocol. This arrangement could be used in a setting where an electronic device like a laptop computer has wireless communication capabilities, but is unable to wirelessly communicate with the wireless-enabled vehicle (perhaps because they operate according to different wireless protocols). In this scenario, vehicle key fob 10 acts as a wireless intermediary between the electronic device and the wireless-enabled vehicle.

Communications circuit 28 is at least partially located within protective housing 18 and is generally designed to provide high-speed communications between electronic devices, like laptop computer 12, and wireless-enabled vehicle 14. According to the exemplary embodiment shown in FIG. 2, communications circuit 28 includes a wired interface 50, a wireless interface 52, and a memory device 54. As with the RKE circuit 22, communications circuit 28 can also include other essential and/or optional components that are known to those skilled in the art, but that are not illustrated here. Communications circuit 28 and RKE circuit 22 can be fabricated on the same printed circuit board (PCB) or they can be implemented according to different circuit configurations, including configurations using separate circuit boards or other substrates.

Wired interface 50 includes communications hardware electronically coupled to wired communications port 26 in order to establish a wired communications link with laptop computer 12 or some other electronic device. The term “electronically coupled,” as used herein, broadly refers to all embodiments where two or more components are in electronic communication with each other, including those where the components are directly connected to each other and those where they are indirectly connected to each other via intervening components, circuits, devices, etc. Depending on the particular needs of the application, wired interface 50 can provide communications circuit 28 with a variety of signal processing capabilities. In the example where wired communications port 26 is a USB port, wired interface 50 is preferably a suitable USB controller and acts as a translator or intermediary for information flowing between the USB cable and wireless interface 52. Of course other high-speed wired interfaces, other than USB, could also be used.

Wireless interface 52 includes wireless communications hardware electronically coupled to wired interface 50 and memory device 54, and is used to establish a high-speed wireless communications link with wireless-enabled vehicle 14. According to one embodiment, wireless interface 52 includes a wireless adapter such as those providing wireless connectivity over a local area network (LAN) (i.e. a Wi-Fi adapter), over a cellular network (i.e. a broadband cellular adapter), or over a very short range (i.e. a Bluetooth adapter), for example. Wireless interface 52 can use a proprietary implementation or adaptation of a standard wireless communications protocol, such as those conforming to the family of IEEE 802.11 protocols, to communicate with a wireless adapter or other wireless communications device installed in vehicle 14.

According to one embodiment, wireless interface 52 utilizes preprogrammed encryption keys (including both symmetric and asymmetric keys), ciphers, or other encoding/decoding tools used to secure wireless transmissions (collectively referred to as security features) stored at both vehicle key fob 10 and wireless-enabled vehicle 14 to establish a secured wireless communications link. These preprogrammed security features provide for secure wireless transmission, but do so without requiring a user to manually enter a complicated encryption key or other long string of characters. The preprogrammed security features could be written to vehicle key fob 10 during manufacturing of the key fob circuitry or at some later time by authorized entities, like a vehicle manufacturer or an authorized dealership. Memory 54 or other memory on the key fob can be used for this purpose. Furthermore, the use of preprogrammed security features allows vehicle key fob 10 to be paired or married to a particular vehicle. This is desirable in that it helps avoid situations where a key fob is used to maliciously transmit or extract unauthorized information from a random vehicle. As is appreciated by skilled artisans, various encryption and security techniques, including those currently used to pair conventional RKE key fobs with a specific vehicle, may be employed.

Memory device 54 is capable of storing a variety of electronic contents and is electronically coupled to wireless interface 52 and/or wired interface 50. In one embodiment, memory device 54 is a high-speed flash memory chip that has one or more application files, drivers, libraries, and other pieces of software stored thereon that is needed to operate interfaces 50 and/or 52. Of course, these and other files could alternatively be stored directly at the appropriate interface or in some other memory component located within vehicle key fob 10. Memory device 54 is preferably provided with adequate memory so that information downloaded from laptop computer 12, such as digital music, video, gaming, or other media files, can be temporarily stored in the memory device if vehicle key fob 10 and wireless-enabled vehicle 14 are not currently in range of each other. Similarly, memory device 54 preferably has memory assets for storing diagnostic information, driver preference information, and other vehicle information uploaded from wireless-enabled vehicle 14. This vehicle information is temporarily stored on vehicle key fob 10 until wired communications port 26 is subsequently connected with laptop computer 12 or some other electronic device, at which point the vehicle information is transferred from the vehicle key fob.

Antenna 30 is at least partially located within protective housing 18 and participates in both the transmission and reception of wireless signals between vehicle key fob 10 and wireless-enabled vehicle 14. The type of antenna used depends, at least in part, on the wireless interface 52 to which it is electronically coupled. In one embodiment, wireless interface 52 includes a Wi-Fi adapter and antenna 30 is a short range antenna designed to send and receive radio frequency (RF) signals with wireless-enabled vehicle 14. These RF signals can be transmitted through protective housing 18, as is generally known in the art. In another embodiment, wireless interface 52 includes a Bluetooth adapter and antenna 30 is a very short range RF antenna designed to wirelessly transmit data over a rather close proximity. It is possible for each of circuits 22 and 28 to have their own dedicated antennas, or a single antenna could be shared by both circuits. The exemplary illustration in FIG. 2 shows a common antenna 30 electronically coupled to both RKE circuit 22 and communications circuit 28, but alternative arrangements can be used.

In an exemplary operation, an application running on laptop computer 12 or some other electronic device can interact with electronic systems of wireless-enabled vehicle 14 so that information is sent to or retrieved from the vehicle. A user first connects a wired connection 46, such as a USB cable, into wired communications port 26. Once a wired connection is established, information is downloaded from laptop computer 12 to vehicle key fob 10. If vehicle key fob 10 and wireless-enabled vehicle 14 are currently within range of one another, then the downloaded information is wirelessly transmitted from the vehicle key fob to the wireless-enabled vehicle over a secure wireless communications link. This link can be used, for instance, to download digital music or other media files to wireless-enabled vehicle 14 through vehicle key fob 10. If, however, the vehicle key fob and the wireless-enabled vehicle are out of range—that is, they are unable to successfully communicate with one another—then the downloaded information is temporarily stored in memory device 54 until a wireless communications link can be established. At that time, the temporarily stored information is sent to wireless-enabled vehicle 14 over a secure wireless communications link.

According to a different exemplary operation, information maintained at the wireless-enabled vehicle, like diagnostic data, personal preference settings, etc., is uploaded from wireless-enabled vehicle 14 to laptop computer 12 or other electronic device through vehicle key fob 10. In this scenario, information is first sent from wireless-enabled vehicle 14 to vehicle key fob 10 through a secure wireless communications link; this assumes that the vehicle and key fob are within range of each other. If vehicle key fob 10 is currently plugged into a USB cable or other wired connection 46 when the uploaded information is received, then the information can be sent along to the electronic device to which it is connected. If it is not plugged in, then the uploaded information is temporarily stored or queued in memory device 54 until a wired connection is made. Preferably, wired interface 50 detects the establishment of a wired communication link and, in response, uploads the information to laptop computer 12 or some other electronic device.

In yet another exemplary operation, information may be sent or retrieved from the vehicle directly from an application running on laptop computer 12 or other electronic device utilizing vehicle key fob 10 as a security apparatus in a short range wireless environment. The short range wireless environment may be hosted at a user's residence. A user first connects a wired connector 46, such as a USB cable, into a wired communication port 26. Once a wired connection is established, information is downloaded from laptop computer 12 to vehicle 14, enabled by the security features embodied in key fob 10.

It should be appreciated that RKE circuit 22 can operate and transmit command signals to wireless-enabled vehicle 14 separately and independently of those being exchanged through communications circuit 28. In one embodiment, RKE circuit 22 and communications circuit 28 communicate with the wireless-enabled vehicle over different wireless channels; that is, the two circuits use different radio frequencies or bands of frequencies or different protocols (e.g., modulation techniques) to communicate with the vehicle. RKE circuit 22 can send command signals to the vehicle over a low-speed wireless link and communications circuit 28 can download and upload information over a generally parallel high-speed wireless link.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, a number of the exemplary components described above could be shared by circuits 22 and 28 or some other component of vehicle key fob 10 instead of being dedicated to one particular circuit or the other. Although circuits 22 and 28 are identified herein as being located at least partially within the key fob 10, they can be contained entirely within the housing 18 as shown in FIG. 2. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A vehicle key fob, comprising:
a protective housing;
a remote keyless entry (RKE) circuit that is at least partially located within the protective housing and initiates RKE functions at the vehicle; and
a communications circuit that is at least partially located within the protective housing and includes a first interface for establishing a first communications link with one or more electronic device(s) and a second interface for establishing a second communications link with the vehicle, wherein the RKE circuit and the communications circuit communicate with the vehicle over different channels.

2. The vehicle key fob of claim 1, wherein the first communications link with the electronic device(s) is a wired communications link and the second communications link with the vehicle is a wireless communications link.

3. The vehicle key fob of claim 2, further comprising a wired communications port that: i) extends through the protective housing, ii) physically receives a wired connection from the electronic device(s), and iii) is electronically coupled to the first interface.

4. The vehicle key fob of claim 3, wherein the wired communications port is a universal serial bus (USB) port and the first interface is a USB controller.

5. The vehicle key fob of claim 2, further comprising an antenna that: i) is at least partially located within the protective housing, and ii) is electronically coupled to the second interface.

6. The vehicle key fob of claim 5, wherein the antenna is a short range radio frequency (RF) antenna and the second interface is a Wi-Fi wireless adapter.

7. The vehicle key fob of claim 2, further comprising a memory device that: i) has one or more electronic file(s) stored thereon, and ii) is electronically coupled to the second interface.

8. The vehicle key fob of claim 7, wherein the electronic file(s) include at least one driver file or application file for use in operating the first or second interface.

9. The vehicle key fob of claim 7, wherein the memory device has preprogrammed security features stored thereon that correspond to security features stored at the vehicle so that the wireless communications link between the vehicle key fob and the vehicle is secured without a user having to enter an encryption key.

10. The vehicle key fob of claim 1, wherein the RKE circuit and the communications circuit are fabricated on the same printed circuit board (PCB).

11. A vehicle key fob, comprising:
a protective housing;
a wired communications port that extends through the protective housing and receives a wired connection from one or more electronic device(s);
an antenna that transmits and receives wireless signals; and
a communications circuit that is at least partially located within the protective housing and includes a first interface that is electronically coupled to the wired communications port for establishing a wired communications link with the electronic device(s), and a second interface that is electronically coupled to the antenna for establishing a wireless communications link and includes a wireless adapter, wherein the first and second interfaces are electronically coupled to one another so that information can be exchanged between the electronic device(s) and the vehicle through the communications circuit.

12. The vehicle key fob of claim 11, wherein the wired communications port is a universal serial bus (USB) port and the first interface is a USB controller.

13. The vehicle key fob of claim 11, wherein the antenna is a radio frequency (RF) antenna and the second interface is a Wi-Fi wireless adapter.

14. The vehicle key fob of claim 11, further comprising a memory device that: i) is at least partially located within the protective housing, ii) has one or more electronic file(s) stored thereon, and iii) is electronically coupled to the second interface.

15. The vehicle key fob of claim 14, wherein the electronic file(s) include at least one driver file or application file for use in operating the first or second interface.

16. The vehicle key fob of claim 14, wherein the memory device has preprogrammed security features stored thereon that correspond to security features stored at the vehicle so that the wireless communications link between the vehicle key fob and the vehicle is secured without a user having to enter an encryption key.

17. The vehicle key fob of claim 11, wherein the RKE circuit and the communications circuit are fabricated on the same printed circuit board (PCB).

18. A vehicle key fob, comprising:
a protective housing;
a remote keyless entry (RKE) circuit that is at least partially located within the protective housing and initiates RKE functions at the vehicle;
a wired communications port that extends through the protective housing and is designed to receive a wired connection from one or more electronic device(s);
an antenna that sends and receives wireless signals; and
a communications circuit that is at least partially located within the protective housing and includes a first interface, a second interface, and a memory device, wherein:
the first interface is electronically coupled to the wired communications port for establishing a wired communications link with the electronic device(s);
the second interface is electronically coupled to the first interface and the antenna for establishing a wireless communications link with a vehicle, and includes a wireless adapter; and
the memory device is electronically coupled to the second interface and has preprogrammed security features stored thereon that correspond to security features stored at the vehicle.
